(19) United States
(12) Patent Application Publication
(10) Pub. No.: US 2026/0179919 A1
(43) Pub. Date: Jun. 25, 2026

(54) SECONDARY BATTERY, NEGATIVE ELECTRODE AND METHOD FOR PRODUCING A NEGATIVE ELECTRODE

(71) Applicants: MURATA MANUFACTURING CO., LTD., Kyoto (JP); The Board of Trustees of the Leland Stanford Junior University, Stanford, CA (US)

(72) Inventors: Hideaki KUWAJIMA, Kyoto (JP); Ryuhei MATSUMOTO, Kyoto (JP); Yuri NAKAYAMA, Kyoto (JP); Yusheng YE, Redwood City, CA (US); Huayue AI, Redwood City, CA (US); Sanzeeda B. SHUCHI, Redwood City, CA (US); Yi CUI, Redwood City, CA (US)

(21) Appl. No.: 18/990,571

(22) Filed: Dec. 20, 2024

(51) Int. Cl. H01M 4/36; H01M 4/38; H01M 4/62; H01M 10/0525

(52) U.S. Cl. CPC H01M 4/366; H01M 4/382; H01M 4/625; H01M 10/0525

(57) ABSTRACT

A secondary battery is provided and including a positive electrode and a negative electrode. A negative electrode includes: a negative electrode current collector; a first negative electrode layer provided on the negative electrode current collector and containing graphene; a lithium metal layer provided on the first negative electrode layer, containing lithium metal, and not including graphene; and a second negative electrode layer provided on the lithium metal layer and containing graphene. In a state in which the potential of the negative electrode is 0 V (vs Li/Li⁺), the first negative electrode layer includes lithium alloy particles containing lithium and a metal that forms an alloy with lithium, and a mass fraction of the lithium alloy particles in the first negative electrode layer is larger than a mass fraction of the lithium alloy particles in the second negative electrode layer.

### BACKGROUND

The present disclosure relates to a secondary battery, a negative electrode and a method for producing a negative electrode.

A lithium metal secondary battery is disclosed in which a polymer is disposed at a lithium metal negative electrode, lithium metal is uniformly deposited, and growth of dendrites of the lithium metal is inhibited.

However, even in the negative electrode of such lithium metal secondary battery, when the negative electrode active material deteriorates, dendrite may still be generated on the surface of the lithium metal deposited on the surface by charging. Since the dendrite causes an internal short circuit by coming into contact with the positive electrode, safety may be insufficient.

### SUMMARY

The present disclosure relates to a secondary battery, a negative electrode and a method for producing a negative electrode.

In an embodiment, a secondary battery includes: a positive electrode; and a negative electrode, wherein the negative electrode includes a negative electrode current collector, a first negative electrode layer being provided on the negative electrode current collector and containing graphene, a lithium metal layer being provided on the first negative electrode layer, the lithium metal layer containing lithium metal and being free from graphene, and a second negative electrode layer being provided on the lithium metal layer and containing graphene, and in a state in which a potential of the negative electrode is 0 V versus Li/Li⁺, the first negative electrode layer includes lithium alloy particles containing lithium and a metal that forms an alloy with the lithium, and a mass fraction of the lithium alloy particles in the first negative electrode layer is larger than a mass fraction of the lithium alloy particles in the second negative electrode layer.

### BRIEF DESCRIPTION OF THE FIGURES

FIG. 1 is a sectional view illustrating an example of a secondary battery according to an embodiment;

FIG. 2 is an enlarged sectional view illustrating a part of a section of an electrode assembly according to FIG. 1;

FIG. 3 is a schematic sectional view illustrating an example of a negative electrode according to an embodiment;

FIG. 4 is a schematic sectional view illustrating an example of the negative electrode according to an embodiment after charging;

FIG. 5 is a schematic sectional view illustrating a negative electrode according to a comparative example after charging;

FIG. 6 is a cutaway view illustrating a different example of the secondary battery according to an embodiment;

FIG. 7 is a schematic sectional view taken along a line VII-VII of FIG. 6;

FIG. 8 is a graph indicating charge curves according to half cells of comparative examples and an example;

FIG. 9 is a graph indicating coulombic efficiency according to the half cells of the comparative examples and the example;

FIG. 10 is a view illustrating a scanning electron microscope (SEM) observation image of a surface of a negative electrode on a separator side according to a first example;

FIG. 11 is a view illustrating an SEM observation image of a section of the negative electrode according to the first example;

FIG. 12 is a view illustrating an SEM observation image of a section of the negative electrode according to the first example;

FIG. 13 is a view illustrating an SEM observation image of a surface of a negative electrode on a separator side according to a first comparative example; and

FIG. 14 is a view illustrating an SEM observation image of a section of the negative electrode according to the first comparative example.

### DETAILED DESCRIPTION

The present disclosure will be described in further detail according to an embodiment. Note that the present disclosure is not limited thereby.

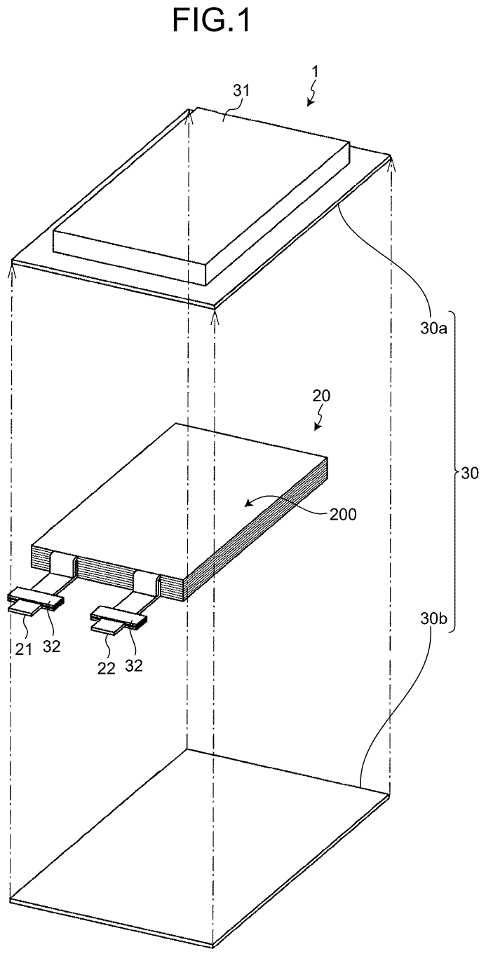

FIG. 1 is a sectional view illustrating an example of a secondary battery according to a first embodiment. A secondary battery 1 illustrated in FIG. 1 is a laminated lithium metal secondary battery. In the present disclosure, a lithium metal secondary battery refers to a secondary battery that performs charging and discharging with lithium metal deposited at a negative electrode. As illustrated in FIG. 1, the secondary battery 1 includes a battery element 20, an exterior member 30, and an adhesive member 32.

The battery element 20 is provided inside the exterior member 30. As illustrated in FIG. 1, the battery element 20 includes an electrode assembly 200, a positive electrode lead 21, and a negative electrode lead 22. The positive electrode lead 21 is a terminal drawn out from a positive electrode 210 to be described later to the outside of the exterior member 30. That is, the positive electrode lead 21 is a terminal serving as a positive pole of a secondary battery 1. In FIG. 1, the positive electrode lead 21 is provided on an end surface of the electrode assembly 200. The negative electrode lead 22 is a terminal drawn out from an inside of a negative pole 220 to be described later to the outside of the exterior member 30. That is, the negative electrode lead 22 is a terminal serving as a negative electrode of the secondary battery 1. In FIG. 1, the negative electrode lead 22 is provided on an end surface of the electrode assembly 200. Details of the electrode assembly 200 will be described later.

The exterior member 30 is a case in which the battery element 20 is housed. The exterior member 30 includes two exterior sheets 30a and 30b. The exterior sheets 30a and 30b each include an insulating layer, a metal layer, and an outermost layer. In the example of FIG. 1, a recess 31 is provided at the exterior sheet 30a. With this configuration, the battery element 20 is housed in the exterior member 30 by housing the battery element 20 into the recess 31 and bonding the peripheral edge portions of the exterior sheets 30a and 30b.

The exterior sheets 30a and 30b each have a structure in which the insulating layer, the metal layer, and the outermost layer are laminated in this order from the inside, that is, from the side where the battery element 20 is provided, and are bonded by lamination or the like. The insulating layers of the exterior sheets 30a and 30b includes, for example, a resin such as polyethylene, polypropylene, modified polyethylene, modified polypropylene, or a polyolefin resin containing ethylene or propylene as a monomer. In this way, the exterior sheets 30a and 30b can lower the moisture permeability of the secondary battery 1, and can improve the airtightness. The metal layer of each of the exterior sheets 30a and 30b includes a plate material or a foil material made of metal such as aluminum, stainless steel, nickel, or iron. The outermost layer may be made of any material. However, the outermost layer is preferably made of, for example, a material having high strength against breakage, piercing, or the like, such as a resin similar to that of the insulating layer, or nylon.

The adhesive member 32 is a member for making the exterior member 30 airtight. The adhesive members 32 are respectively provided between the exterior member 30 and the positive electrode lead 21 and between the exterior member 30 the negative electrode lead 22. The material of the adhesive member 32 preferably has adhesion to the positive electrode lead 21 and the negative electrode lead 22. For example, when the positive electrode lead 21 and the negative electrode lead 22 include a metal material, a polyolefin resin such as polyethylene, polypropylene, modified polyethylene, or modified polypropylene is used as the adhesive member 32. In this way, the adhesive member 32 can seal the gap between the exterior member 30 and the positive electrode lead 21 and between the exterior member 30 the negative electrode lead 22, so that the inside of the exterior member 30 can be made airtight.

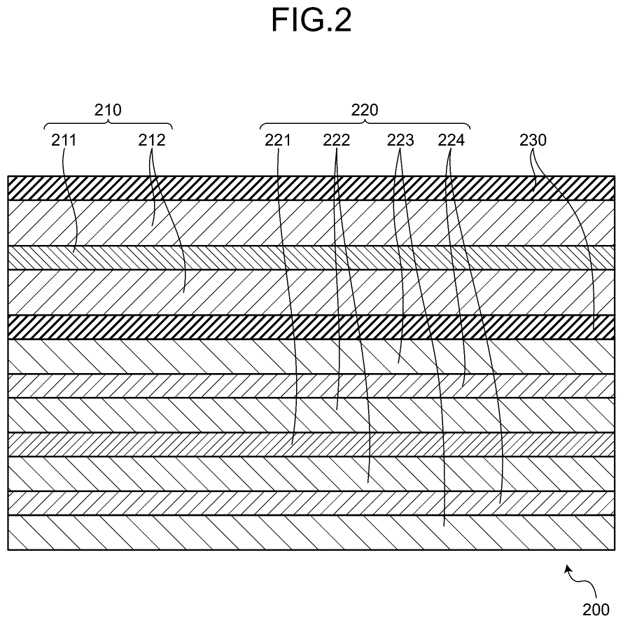

FIG. 2 is an enlarged sectional view illustrating a part of a section of an electrode assembly according to FIG. 1. More specifically, FIG. 2 is a sectional view illustrating a part of one layer of the positive electrode 210 and one layer of the negative electrode 220 in the electrode assembly 200. As illustrated in FIG. 2, the electrode assembly 200 includes the positive electrode 210, the negative electrode 220, and a separator 230. In the secondary battery 1, the electrode assembly 200 has a structure in which the positive electrode 210 and the negative electrode 220 are laminated in a thickness direction with the separator 230 interposed therebetween. The positive electrode 210 and the negative electrode 220 included in the electrode assembly 200 are layered members for a charge-discharge reaction of the secondary battery according to the first embodiment.

The positive electrode 210 includes a positive electrode current collector 211 and a positive electrode mixture layer 212. In the positive electrode 210, the positive electrode current collector 211 is laminated between the positive electrode mixture layers 212. In other words, the positive electrode mixture layer 212 is formed on both surfaces of the positive electrode current collector 211.

The positive electrode current collector 211 is a conductor layer, and for example, an aluminum foil and a stainless-steel foil can be used. In the example of FIG. 1, the shape of the positive electrode current collector 211 is a rectangular sheet including a protrusion on the positive electrode lead 21 side in plan view in the thickness direction. The protrusion of the positive electrode current collector 211 is coupled to the positive electrode lead 21.

The positive electrode mixture layer 212 is a layer containing a positive electrode active material. The positive electrode mixture layer 212 contains a positive electrode active material, a positive electrode binder, and a positive electrode conductive additive. The positive electrode mixture layer 212 is not limited to the materials described above, and may further contain, for example, a dispersant.

The positive electrode active material is preferably a lithium-containing compound such as a lithium-containing composite oxide or a lithium-containing phosphoric acid compound. The lithium-containing composite oxide is an oxide containing lithium and one or more elements other than lithium as constituent elements. The lithium-containing composite oxide has, for example, a layered rock-salt or spinel crystal structure. The lithium-containing phosphoric acid compound is a phosphoric acid compound containing lithium and one or more elements other than lithium as constituent elements. The lithium-containing phosphoric acid compound has, for example, an olivine crystal structure, or the like. Specific examples of the lithium-containing composite oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the lithium-containing phosphoric acid compound include LiFePO₄, LiMnPO₄, LiFe_{0.5}Mn_{0.5}PO₄, and LiFe_{0.3}Mn_{0.7}PO₄.

The positive electrode binder contained in the positive electrode mixture layer 212 may include any material, for example, one or more of synthetic rubbers and polymer compounds. Examples of the synthetic rubber include styrene butadiene-based rubber, fluorine-based rubber, and ethylene propylene diene. Examples of the polymer compound include polyvinylidene fluoride (PVdF), and polyimide.

The conductive additive contained in the positive electrode mixture layer 212 may include any material, for example, a carbon material. Examples of the carbon material include graphite, carbon black, acetylene black, and Ketjen black. Provided, however, that the conductive additive contained in the positive electrode mixture layer 212 is not limited thereto as long as it is a material having conductivity, and may be a metal material, a conductive polymer, or the like.

The separator 230 is a film that allows lithium ions to pass therethrough while insulating the positive electrode 210 and the negative electrode 220 from each other. The separator 230 is provided between the principal surface of the positive electrode 210 and the principal surface of the negative electrode 220 so that the positive electrode 210 and the negative electrode 220 are not in direct contact with each other. In the example of FIG. 1, the shape of the separator 230 is a rectangular sheet in plan view in the thickness direction.

The material of the separator 230 is preferably electrically stable, chemically stable with respect to the positive electrode active material, the negative electrode active material, and the electrolytic solution, and has an insulating property. As the separator 230, for example, a layer including a polymeric nonwoven fabric, a porous film, or a glass or ceramic fiber can be used. The material of the separator 230 more preferably includes a porous polyolefin film. In this way, the safety of the secondary battery can be improved by the short circuit preventing effect and the shutdown effect.

The separator 230 is impregnated with the electrolytic solution. In the example of FIG. 1, a space in the exterior member 30 is filled with the electrolytic solution. The electrolytic solution is a nonaqueous electrolytic solution containing an electrolyte salt and a solvent that dissolves the electrolyte salt.

Examples of the electrolyte salt include lithium salts such as lithium perchlorate (LiClO₄), lithium hexafluorophosphate (LiPF₆), lithium tetrafluoroborate (LiBF₄), lithium bis(trifluoromethanesulfonyl)imide (LiN(SO₂CF₃)₂), lithium bis(pentafluoroethanesulfonyl)imide (LiN(SO₂C₂F₅)₂), and lithium hexafluoroarsenate (LiAsF₆).

Examples of the solvent include nonaqueous solvents such as: lactone-based solvents such as γ-butyrolactone, γ-valerolactone, δ-valerolactone, and ε-caprolactone; carbonate-based solvents such as ethylene carbonate, propylene carbonate, butylene carbonate, vinylene carbonate, dimethyl carbonate, ethyl methyl carbonate, and diethyl carbonate; ether-based solvents such as 1,2-dimethoxyethane, 1-ethoxy-2-methoxyethane, 1,2-diethoxyethane, tetrahydrofuran, and 2-methyltetrahydrofuran; nitrile-based solvents such as acetonitrile; sulfolane-based solvents; phosphoric acids; phosphate solvents; and pyrrolidones.

The electrolytic solution may further contain an additive such as a fluorinated carboxylate, a sulfonate, a sulfonic acid anhydride, or a carboxylic acid anhydride.

Hereinafter, the negative electrode 220 according to the first embodiment will be described in further detail.

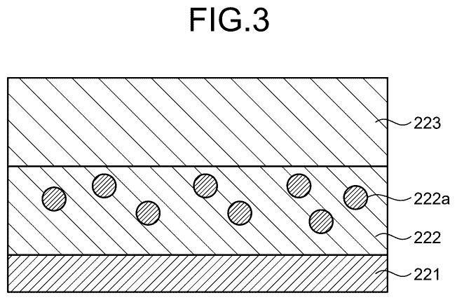

FIG. 3 is a schematic sectional view illustrating an example of a negative electrode according to the first embodiment before charging. As illustrated in FIG. 3, the negative electrode 220 according to the first embodiment before charging includes a negative electrode current collector 221, a first negative electrode layer 222, and a second negative electrode layer 223. In the example of FIG. 3, in the negative electrode 220, the negative electrode current collector 221, the first negative electrode layer 222, and the second negative electrode layer 223 are laminated in this order.

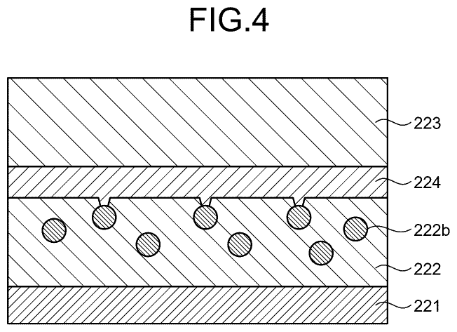

FIG. 4 is a schematic sectional view illustrating an example of the negative electrode according to the first embodiment after charging. As illustrated in FIG. 4, the negative electrode 220 according to the first embodiment after charging includes the negative electrode current collector 221, the first negative electrode layer 222, the second negative electrode layer 223, and a lithium metal layer 224. In the example of FIG. 4, in the negative electrode 220, the negative electrode current collector 221, the first negative electrode layer 222, the lithium metal layer 224, and the second negative electrode layer 223 are laminated in this order. That is, the lithium metal layer 224 is a layer generated by charging the negative electrode 220 illustrated in FIG. 3. In the present disclosure, the lithium metal layer 224 is a layer containing a elemental lithium metal and is a layer free from graphene.

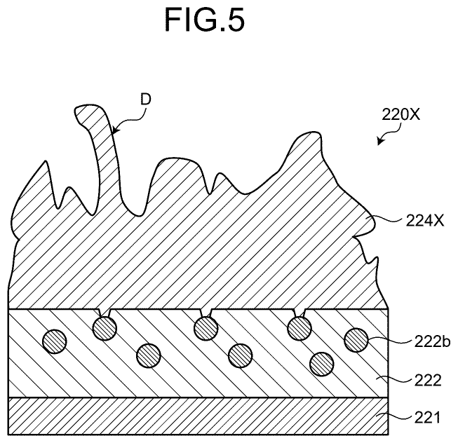

FIG. 5 is a schematic sectional view illustrating a negative electrode according to a comparative example after charging. The negative electrode according to FIG. 5 is a negative electrode 220X obtained by excluding the second negative electrode layer 223 from the negative electrode 220 according to the first embodiment, and is a negative electrode according to a first comparative example to be described later. In the example of FIG. 5, in the negative electrode 220, the negative electrode current collector 221, the first negative electrode layer 222, and the lithium metal layer 224 are laminated in this order.

The secondary battery is manufactured so that the theoretical capacities of the positive electrode active material and the negative electrode active material are the same in order to improve the energy density. In such a secondary battery, dendritic crystals (dendrites) may be generated on the surface of the lithium metal layer formed on the surface of the negative electrode active material during charging. In the following description, the dendritic crystal will be described as a dendrite D. As illustrated in FIG. 5, when the dendrite D is generated on the surface of a deposited lithium metal layer 224X, the dendrite D has a sharp shape. Thus, the dendrite D may penetrate the separator 230 and reach the positive electrode 210. As a result, an internal short circuit may occur, which may cause heat generation or ignition of the secondary battery.

Hereinafter, the negative electrode current collector 221, the first negative electrode layer 222, and the second negative electrode layer 223 included in the negative electrode 220 according to the first embodiment will be described in detail.

The negative electrode current collector 221 contains copper as a main component. In the present disclosure, the expression “the negative electrode current collector 221 contains copper as a main component” means that the content of copper in the negative electrode current collector 221 is 90 mol % or more. As the negative electrode current collector 221, for example, a copper foil can be used. In the example of FIG. 1, the shape of the negative electrode current collector 221 is a rectangular sheet including a protrusion on the negative electrode lead 22 side in plan view in the thickness direction. The protrusion of the negative electrode current collector 221 is coupled to the negative electrode lead 22.

The first negative electrode layer 222 and the second negative electrode layer 223 are layers containing graphene. In the first embodiment, the first negative electrode layer 222 and the second negative electrode layer 223 are layers obtained by laminating a plurality of layers of reduced graphene oxide. In the present disclosure, the reduced graphene oxide is graphene oxide having an oxygen content of 40 mass % or less. Since the reduced graphene oxide is excellent in dispersibility and conductivity in a polar solvent, the conductivity can be improved while simplifying the manufacturing process of the first negative electrode layer 222 and the second negative electrode layer 223. Whether or not the first negative electrode layer 222 and the second negative electrode layer 223 contain reduced graphene oxide can be measured by Raman spectroscopy or X-ray photoelectron spectroscopy (XPS) for the first negative electrode layer 222 and the second negative electrode layer 223.

In a state in which the potential of the negative electrode is 0 V (vs Li/Li⁺), the first negative electrode layer 222 includes lithium alloy particles 222b. The lithium alloy particles refer to particles including a lithium alloy containing lithium and a metal M. The metal M is a metal that forms an alloy with lithium. The metal M is preferably at least one of zinc (Zn), silicon (Si), magnesium (Mg), aluminum (Al), gold (Au), platinum (Pt), or silver (Ag). In a state in which the potential of the negative electrode is 0 V (vs Li/Li⁺), since the first negative electrode layer 222 includes the lithium alloy particles 222b, the lithium metal layer 224 is formed with the lithium alloy particles 222b as a starting point. Thus, the first negative electrode layer 222 and the lithium metal layer 224 are firmly bonded to each other due to the anchor effect by the lithium alloy particles 222b. In this way, the growth of the lithium metal layer 224 on the second negative electrode layer 223 side can be promoted. Therefore, lithium metal can be inhibited from being deposited on the surface of the negative electrode 220, and generation of the dendrite D can be inhibited.

Here, in order to make the first negative electrode layer 222 contain the lithium alloy particles 222b in a state in which the potential of the negative electrode is 0 V (vs Li/Li⁺), it is sufficient that the first negative electrode layer 222 be made containing metal M oxide particles 222a, as illustrated in FIG. 3. Here, metal M oxide particles 222a is an example of metal compound particles, which contain compound of the metal M, in the present disclosure. In this way, in a state in which the potential of the negative electrode is 0 V (vs Li/Li⁺), the metal M oxide particles 222a react with lithium ions in the electrolytic solution and are reduced by charging. This reaction proceeds inside the metal M oxide particles 222a, thereby forming the lithium alloy particles 222b. That is, the lithium alloy particles 222b are formed from the metal M oxide particles 222a by charging. Lithium metal is further attached to the formed lithium alloy particle 222b serving as a core of lithium metal. As a result, the lithium alloy particles 222b promote the growth of the lithium metal layer 224 between the first negative electrode layer 222 and the second negative electrode layer 223.

The presence or absence and composition of the lithium alloy particles 222b in the first negative electrode layer 222 and the second negative electrode layer 223 can be measured by taking out each of the first negative electrode layer 222 and the second negative electrode layer 223 as a sample in a state in which the potential of the negative electrode is 0 V (vs Li/Li⁺) and then acquiring energy dispersive X-ray spectroscopy (EDS) mapping of a section in the thickness direction. More specifically, the EDS mapping of the sections of the first negative electrode layer 222 and the second negative electrode layer 223 in the thickness direction are acquired for Li and the metal M. When the distribution of Li and the distribution of the metal M at least partially overlap each other, it can be determined that the lithium alloy particles 222b containing Li and the metal M are formed. Another measurement method includes acquiring a photoelectron spectrum of the sample for Li and the metal M by X-ray photoelectron spectroscopy (XPS). When a peak derived from Li and the metal M appears in the photoelectron spectrum, it can be determined that the lithium alloy particles 222b containing Li and the metal M are formed.

The mass fraction of the lithium alloy particles in the first negative electrode layer 222 is larger than the mass fraction of the lithium alloy particles in the second negative electrode layer 223. Accordingly, the lithium metal layer 224 is more firmly bonded to the first negative electrode layer 222 than to the second negative electrode layer 223 due to the anchor effect by the lithium alloy particles 222b. Thus, the growth of the lithium metal layer 224 on the second negative electrode layer 223 side can be promoted. Therefore, lithium metal can be inhibited from being deposited on the surface of the negative electrode 220, and generation of the dendrite D can be inhibited.

Here, in order to make the mass fraction of the lithium alloy particles in the first negative electrode layer 222 larger than the mass fraction of the lithium alloy particles in the second negative electrode layer 223 in a state in which the potential of the negative electrode is 0 V (vs Li/Li⁺), it is sufficient that the mass fraction of the metal M oxide particles 222a in the first negative electrode layer 222 be made larger than the mass fraction of the metal M oxide particles 222a in the second negative electrode layer 223, as illustrated in FIG. 3. In this way, the absolute value of the lithium nucleation overvoltage in the first negative electrode layer 222 can be made smaller than the absolute value of the lithium nucleation overvoltage in the second negative electrode layer 223. In the present disclosure, the lithium nucleation overvoltage refers to a voltage at which the potential of lithium metal deposited at the negative electrode 220 drops within a range of 0 V (vs Li/Li⁺) or less when charging is performed using lithium metal as a positive electrode and a target to be measured as a negative electrode. Here, when the absolute value of the lithium nucleation overvoltage is small, it can be said that lithium metal is more likely to be deposited because the energy barrier for the nucleation of the lithium metal is low. Accordingly, during charging of the secondary battery 1, the lithium metal is more likely to be deposited on the surface of the first negative electrode layer 222 on the opposite side of the negative electrode current collector 221 than on the surface of the second negative electrode layer 223 on the opposite side of the negative electrode current collector 221. As illustrated in FIG. 4, this makes it possible to form the lithium metal layer 224 between the first negative electrode layer 222 and the second negative electrode layer 223 in the present embodiment. Therefore, even when the dendrite D is generated on the surface of the lithium metal layer 224 on the separator 230 side, the second negative electrode layer 223 can protect the separator 230 and the positive electrode 210 from the dendrite D, and the safety of the secondary battery 1 can be improved.

The mass fraction of the lithium alloy particles 222b in the first negative electrode layer 222 is preferably 10 mass % or more. In this way, the adhesiveness between the first negative electrode layer 222 and the lithium metal layer 224 can be sufficiently improved. The mass fraction of the lithium alloy particles 222b in the first negative electrode layer 222 is preferably 50 mass % or less. This makes it possible to prevent or reduce a decrease in ion conductivity in the first negative electrode layer 222. The mass fraction of the lithium alloy particles in the second negative electrode layer 223 is preferably 0 mass %. That is, the second negative electrode layer 223 is preferably free from lithium alloy particles. This makes it possible to inhibit the second negative electrode layer 223 and the lithium metal layer 224 from firmly bonding to each other, and to inhibit generation of the dendrite D due to deposition of lithium metal on the surface of the negative electrode 220.

The mass fractions of the lithium alloy particles 222b in the first negative electrode layer 222 and the second negative electrode layer 223 can be calculated by inductively coupled plasma (ICP) atomic emission spectroscopy after each of the first negative electrode layer 222 and the second negative electrode layer 223 is taken out as a sample in a state in which the potential of the negative electrode is 0 V (vs Li/Li⁺). More specifically, the mass fraction of the lithium alloy particles 222b can be calculated as a proportion of the mass of the lithium alloy particles to the sum of the masses of graphene and the lithium alloy particles by measuring the weight of the sample, then dissolving the sample in the acid solution, and analyzing the masses of the metal M and Li by the ICP atomic emission spectroscopy. Another calculation method includes a method of calculation with a thermogravimetry-differential thermal analyzer (TG-DTA). Graphene is volatilized as carbon dioxide by combustion. Accordingly, the mass of graphene can be measured from the weight change of the sample at the combustion temperature of graphene, and the mass of the metal M can be measured from the weight of the sample after combustion. Therefore, the mass fraction of the lithium alloy particles 222b can be calculated in the same manner as described above.

Note that the first negative electrode layer 222 may contain a substance other than carbon, lithium, and the metal M in a state in which the potential of the negative electrode is 0 V (vs Li/Li⁺). For example, the first negative electrode layer 222 may contain the metal M oxide particles 222a.

The adhesive force between the first negative electrode layer 222 and the lithium metal layer 224 is preferably larger than the adhesive force between the second negative electrode layer 223 and the lithium metal layer 224. This makes it possible to promote the growth of the lithium metal layer 224 between the lithium metal layer 224 and the second negative electrode layer 223. Thus, deposition of the lithium metal on the surface of the second negative electrode layer 223 on the opposite side of the first negative electrode layer 222 can be inhibited, and generation of the dendrite D can be further inhibited.

The comparison of the adhesive force between the first negative electrode layer 222 and the lithium metal layer 224 with the adhesive force between the second negative electrode layer 223 and the lithium metal layer 224 can be measured by the testing method for tensile strength described in JIS K6849. More specifically, the negative electrode 220 in which the lithium metal layer 224 is generated is taken out from the secondary battery 1 and pulled from both sides in the laminating direction of the negative electrode 220 to perform the testing method for tensile strength. In this test, when the second negative electrode layer 223 is peeled off from the lithium metal layer 224 earlier than the first negative electrode layer 222 is, it can be said that the adhesive force between the first negative electrode layer 222 and the lithium metal layer 224 is larger than the adhesive force between the second negative electrode layer 223 and the lithium metal layer 224. On the other hand, when the first negative electrode layer 222 is peeled off from the lithium metal layer 224 earlier than the second negative electrode layer 223 is, it can be said that the adhesive force between the first negative electrode layer 222 and the lithium metal layer 224 is smaller than the adhesive force between the second negative electrode layer 223 and the lithium metal layer 224.

Although the secondary battery according to the first embodiment has been described above, the secondary battery according to the first embodiment is not limited to that illustrated in FIG. 1.

For example, a simple substance of the metal M or an alloy of the metal M and Li contained in the first negative electrode layer 222 may be present between the first negative electrode layer 222 and the second negative electrode layer 223.

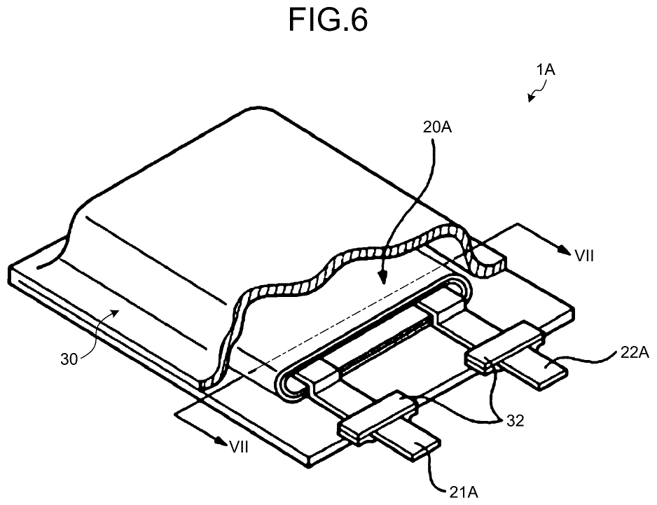

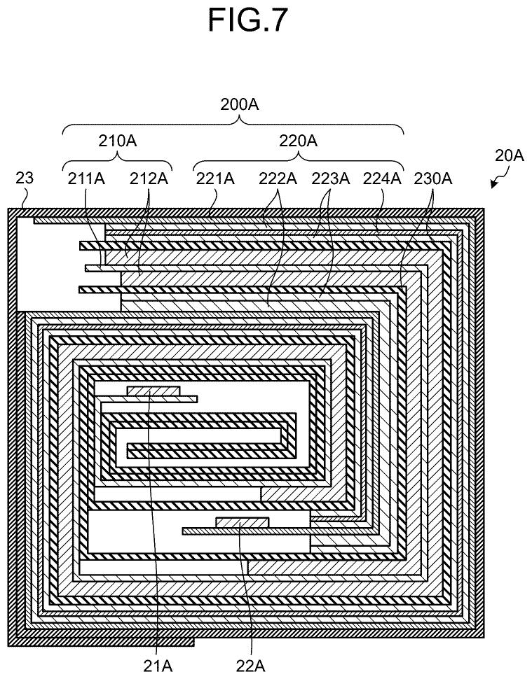

FIG. 6 is a cutaway view illustrating a different example of the secondary battery according to the first embodiment. FIG. 7 is a schematic sectional view taken along a line VII-VII of FIG. 6. The secondary battery according to the first embodiment may be the secondary battery according to FIGS. 6 and 7. The secondary battery 1A illustrated in FIGS. 6 and 7 is different from the example according to FIG. 1 in that the electrode assembly 200A has a structure in which a positive electrode lead 21A and a negative electrode lead 22A are wound around the center. In the following description, the same components as those in FIGS. 1 and 2 are denoted by reference numerals, and description thereof is omitted.

A battery element 20A is provided inside the exterior member 30. As illustrated in FIG. 7, the battery element 20A includes an electrode assembly 200A, the positive electrode lead 21A, the negative electrode lead 22A, and a protection member 23. The positive electrode lead 21A is a terminal drawn out from the inside of the battery element 20A to the outside of the exterior member 30, and the positive electrode lead 21A is provided at or near the center of the battery element 20A. The negative electrode lead 22A is a terminal drawn out from the inside of the battery element 20A to the outside of the exterior member 30, and the negative electrode lead 22A is provided at or near the center of the battery element 20A. The protection member 23 is a member that protects the outside of the battery element 20A. The protection member 23 is provided so as to be wound around the electrode assembly 200A. The protection member 23 is, for example, an insulating tape.

In the example in FIG. 7, the electrode assembly 200A is a laminate for a charge-discharge reaction of the secondary battery according to the first embodiment. The electrode assembly 200A includes: a positive electrode 210A including a positive electrode current collector 211A and a positive electrode mixture layer 212A; a negative electrode 220A including a negative electrode current collector 221A, a first negative electrode layer 222A, a second negative electrode layer 223A, and a lithium metal layer 224A; and a separator 230A. The electrode assembly 200A has a structure in which the positive electrode lead 21A and the negative electrode lead 22A are wound around the center. The negative electrode current collector 221A, the first negative electrode layer 222A, the second negative electrode layer 223A, the separator 230A, the positive electrode mixture layer 212A, the positive electrode current collector 211A, the positive electrode mixture layer 212A, the separator 230A, the second negative electrode layer 223A, the lithium metal layer 224A, and the first negative electrode layer 222A are laminated in this order from the outside, that is, from the protection member 23 side. In the electrode assembly 200A, layers other than the negative electrode current collector 221A, the separator 230A, and the positive electrode current collector 211A are not provided near the positive electrode lead 21A and the negative electrode lead 22A. With this structure, the positive electrode current collector 211A is coupled to the positive electrode lead 21A, and the negative electrode current collector 221A is coupled to the negative electrode lead 22A.

As described above, the secondary battery 1 according to the embodiment is a secondary battery including the positive electrode 210 and the negative electrode 220. The negative electrode 220 includes: the negative electrode current collector 221; the first negative electrode layer 222 provided on the negative electrode current collector 221 and containing graphene; the lithium metal layer 224 provided on the first negative electrode layer 222, the lithium metal layer 224 containing lithium metal, and being free from graphene; and the second negative electrode layer 223 provided on the lithium metal layer 224 and containing graphene. In a state in which the potential of the negative electrode is 0 V (vs Li/Li⁺), the first negative electrode layer 222 includes the lithium alloy particles 222b containing lithium and the metal M that forms an alloy with lithium, and the mass fraction of the lithium alloy particles 222b in the first negative electrode layer 222 is larger than the mass fraction of the lithium alloy particles 222b in the second negative electrode layer 223.

In the secondary battery 1 according to the embodiment, the lithium metal layer 224 is more firmly bonded to the first negative electrode layer 222 than to the second negative electrode layer 223 due to the anchor effect by the lithium alloy particles 222b. Thus, the growth of the lithium metal layer 224 on the second negative electrode layer 223 side can be promoted. Therefore, lithium metal can be inhibited from being deposited on the surface of the negative electrode 220, and generation of the dendrite D can be inhibited, so that safety can be improved.

As a desirable aspect, the mass fraction of the lithium alloy particles 222b in the first negative electrode layer 222 is 10 mass % or more and 50 mass % or less. This makes it possible to sufficiently improve the adhesiveness between the first negative electrode layer 222 and the lithium metal layer 224 while preventing or reducing a decrease in ion conductivity in the first negative electrode layer 222.

As a desirable aspect, at least one of the first negative electrode layer 222 or the second negative electrode layer 223 contains reduced graphene oxide. This makes it possible to improve the conductivity while simplifying the manufacturing process of at least one of the first negative electrode layer 222 or the second negative electrode layer 223.

As a desirable aspect, the adhesive force between the first negative electrode layer 222 and the lithium metal layer 224 is larger than the adhesive force between the second negative electrode layer 223 and the lithium metal layer 224. This makes it possible to promote the growth of the lithium metal layer 224 between the lithium metal layer 224 and the second negative electrode layer 223. Thus, deposition of the lithium metal on the surface of the second negative electrode layer 223 on the opposite side of the first negative electrode layer 222 can be inhibited, and generation of the dendrite D can be further inhibited, and therefore safety can be further improved.

As a desirable aspect, the metal M that forms an alloy with lithium is at least one of Zn, Si, Mg, Al, Au, Pt, or Ag. Accordingly, the lithium metal layer 224 is still more firmly bonded to the first negative electrode layer 222 than to the second negative electrode layer 223 due to the anchor effect by the lithium alloy particles 222b. Thus, the growth of the lithium metal layer 224 on the second negative electrode layer 223 side can be further promoted. Therefore, lithium metal can be further inhibited from being deposited on the surface of the negative electrode 220, and generation of the dendrite D can be further inhibited, so that safety can be further improved.

### EXAMPLE

An example will be described according to an embodiment. Note that the present disclosure is not limited by the example. Table 1 is a table indicating configurations of negative electrodes and experimental results according to a first example and the first comparative example and a second comparative example. Here, in the column of “Presence of first negative electrode layer” in Table 1, “Y” indicates that there is a first negative electrode layer containing lithium alloy particles, and “N” indicates that there is no first negative electrode layer containing lithium alloy particles. In the column of “Presence of second negative electrode layer” in Table 1, “Y” indicates that there is a second negative electrode layer free from lithium alloy particles, and “N” indicates that there is no second negative electrode layer free from lithium alloy particles. In the column of “Generation of dendrite on surface of negative electrode” in Table 1, “Y” indicates that a dendrite was generated on the surface of the negative electrode, and “N” indicates that no dendrite was generated on the surface of the negative electrode.

TABLE 1

| | Presence of | Presence of | | Generation of |
|---|---|---|---|---|
| | first | second | Lithium | dendrite on |
| | negative | negative | nucleation | surface of |
| | electrode | electrode | overvoltage | negative |
| | layer | layer | (mV) | electrode |
| First | Y | Y | −17 | N |
| example | | | | |
| First | Y | N | −19 | Y |
| comparative | | | | |
| example | | | | |
| Second | N | Y | −30 | Y |
| comparative | | | | |
| example | | | | |

A negative electrode current collector according to the first example was produced by punching a Cu foil (Pred Materials) to form a 2 cm²-sized piece.

The first negative electrode layer according to the first example was produced by the following method. First, zinc oxide powder (manufactured by Sigma-Aldrich Co. LLC) was added to a slurry containing 1.1 mass % of graphene oxide (GO-3, manufactured by Hangzhou Gaoxi Technology Co., Ltd.), and the mixture was stirred for 20 minutes with a planetary centrifugal mixer (Thinky) to prepare a first negative electrode mixture. Here, the amount of zinc oxide powder added was prepared so as to occupy 33 mass % of the dried first negative electrode mixture. Thereafter, the first negative electrode mixture was applied to a glass plate with a doctor blade with a gap set to 15 milli-inch (0.38 mm), and dried at room temperature overnight. Then, the dried first negative electrode mixture was peeled off from the glass plate, and brought into contact with a hot plate heated to 390° C. in a glovebox in an argon atmosphere to be reduced. Thereafter, the reduced first negative electrode mixture was punched to form a 1 cm²-sized piece, and the first negative electrode layer according to the first example was produced.

The second negative electrode layer according to the first example was prepared by the following method. First, a slurry containing 1.1 mass % of graphene oxide (GO-3, Hangzhou Gaoxi Technology Co., Ltd.) was used as a second negative electrode mixture, and the second negative electrode mixture was applied to a glass plate with a doctor blade with a gap set to 15 milli-inch (0.38 mm) and dried at room temperature overnight. Then, the dried second negative electrode mixture was peeled off from the glass plate, and brought into contact with a hot plate heated to 390° C. in a glovebox in an argon atmosphere to be reduced. Thereafter, the reduced second negative electrode mixture was punched to form a 1 cm²-sized piece, and the second negative electrode layer according to the first example was produced.

The electrolytic solution according to the first example was prepared in a glovebox in an argon atmosphere with an oxygen concentration of 0.2 ppm or less and a moisture concentration of 0.01 ppm or less. The electrolytic solution was prepared by adding lithium bis(trifluoromethanesulfonyl)imide (LiTFSI, Solvay) and lithium nitrate (LiNO₃, Aldrich) as solutes to a mixed solution obtained by mixing dimethyl ether (Aldrich) and 1,3-dioxolane (Aldrich) as solutions at a volume ratio of 1:1, and stirring the mixture overnight. The electrolytic solution was prepared so that the concentration of LiTFSI was 1 mol/L and the concentration of LiNO₃ was 1 mass %.

Thereafter, a half cell was produced by using the produced negative electrode. The half cell was a 2023 type coin cell. The half cell was produced in a glovebox in an argon atmosphere with an oxygen concentration of 0.2 ppm or less and a moisture concentration of 0.01 ppm or less. Here, the positive electrode of the half cell was a lithium metal foil obtained by scraping off the surface of a lithium foil (Alfa Aesar) having a thickness of 750 μm and a purity of 99.9% to remove the oxide film, and then punching the lithium metal foil to form a 1 cm²-sized piece. As a separator of the half cell, a polypropylene-polyethylene-polypropylene separator (Celgard) having a three-layer structure and a thickness of 25 μm was used. A spacer was a stainless-steel foil having a thickness of 0.5 mm. First, the positive electrode was attached to the spacer, and placed in an anode can in which a spring having a thickness of 0.5 mm and two spacers were placed. Subsequently, the negative electrode current collector, the first negative electrode layer, and the second negative electrode layer were laminated to form a negative electrode, and the negative electrode was installed in a cathode can. Then, the anode can and the cathode can were stacked with the separator impregnated with the prepared electrolytic solution interposed therebetween, and then caulked to prepare a coin cell.

### Charge Test

A charge test was performed on the produced half cell. The charge test was performed by using a battery cycler (Arbin) in a glovebox in an argon atmosphere with an oxygen concentration of 0.2 ppm or less and a moisture concentration of 0.01 ppm or less. The charge test was performed in such a manner that CC charge at 0.1 mA/cm² was performed until reaching 1 mAh/cm² in the range of 0 V (vs Li/Li⁺) or less in the charge curve. In the charge test, after the voltage dropped in a range where the voltage was 0 V (vs Li/Li⁺) or less in the charge curve, charging was performed until the voltage increased again. At this time, in the charge curve obtained in the measurement, the voltage of the minimum value of the charge curve in a region where the voltage was 0 V (vs Li/Li⁺) or less was measured as the lithium nucleation overvoltage.

### EDS Measurement

After the charge test, the half cell was disassembled, and an EDS mapping image in a section in the thickness direction of the first negative electrode layer was acquired by an EDS (EMAX Evolution X-Max20, HORIBA, Ltd.) to examine the presence or absence of lithium alloy particles. As a result, it was confirmed that lithium alloy particles were present in the first negative electrode layers of both the first example and the first comparative example.

### Charge-Discharge Test

The produced half cell was subjected to a charge-discharge test to measure the coulombic efficiency. In the charge-discharge test, a cycle of charging at 0.5 mA/cm² until reaching 1 mAh/cm² and discharging at 0.5 mA/cm² to a cutoff potential of 1 V was repeated, and a value obtained by dividing the discharge capacity by the charge capacity was calculated as coulombic efficiency (C.E.) for each cycle number.

### SEM Observation

After the charge test, the half cell was disassembled, and the surface of the negative electrode on the separator side and the section of the negative electrode were observed by using an SEM. The SEM observation was performed under the following conditions.
SEM: S-4800 (Hitachi High-Tech Corporation)
Acceleration voltage: 3.0 kV

### First Comparative Example

The negative electrode according to the first comparative example was used to produce a half cell in the same manner as in the first example except that the second negative electrode layer was not laminated. A charge test, a charge-discharge test, and SEM observation were performed.

### Second Comparative Example

The negative electrode according to the second comparative example was used to produce a half cell in the same manner as in the first example except that the first negative electrode layer was not laminated. A charge test, a charge-discharge test, and SEM observation were performed.

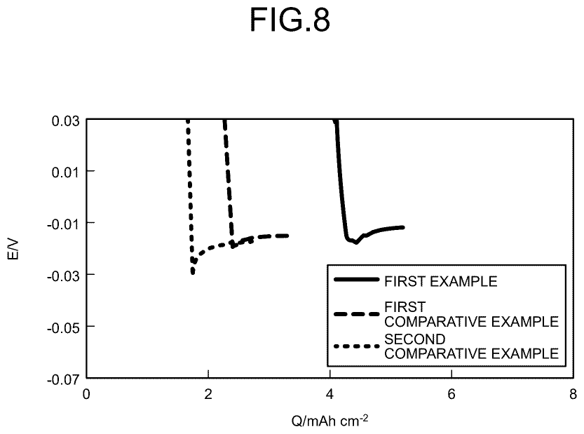

FIG. 8 is a graph indicating charge curves according to half cells of the comparative examples and the example. From the graph given in FIG. 8, the lithium nucleation overvoltage was the value stated in Table 1. As indicated in FIG. 8 and Table 1, in the second comparative example in which only the second negative electrode layer free from lithium alloy particles was laminated on the negative electrode current collector, the absolute value of the lithium nucleation overvoltage was smaller than that in the first comparative example in which only the first negative electrode layer containing lithium alloy particles was laminated on the negative electrode current collector. Therefore, it is considered that a lithium metal layer is more likely to be formed on the surface of the first negative electrode layer containing the lithium alloy particles than on the surface of the second negative electrode layer free from the lithium alloy particles.

As indicated in FIG. 8 and Table 1, in the first example in which the second negative electrode layer free from lithium alloy particles was laminated on the first negative electrode layer containing lithium alloy particles, the absolute value was closer to the absolute value of the first comparative example in which only the first negative electrode layer was laminated on the negative electrode current collector than to the value of the second comparative example in which only the second negative electrode layer was laminated on the negative electrode current collector. As can be seen from this, when the negative electrode includes the first negative electrode layer containing lithium alloy particles and the second negative electrode layer free from lithium alloy particles (the first example), the nucleation overvoltage is similar to that in the case of including only the first negative electrode layer containing lithium alloy particles (the first comparative example). Accordingly, it is considered that even when the negative electrode is formed by laminating the second negative electrode layer free from lithium alloy particles on the first negative electrode layer containing lithium alloy particles, the lithium metal layer is more easily formed during charging on the surface of the first negative electrode layer containing lithium alloy particles than on the surface of the second negative electrode layer free from lithium alloy particles.

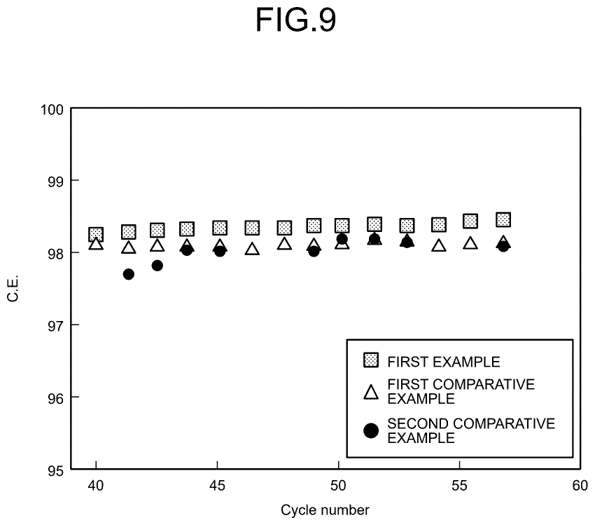

FIG. 9 is a graph indicating coulombic efficiency according to the half cells of the comparative examples and the example. As indicated in FIG. 9, in the negative electrode according to the first example in which the second negative electrode layer free from lithium alloy particles was laminated on the first negative electrode layer containing lithium alloy particles, the coulombic efficiency at 40 cycles or more was improved as compared with the first comparative example and the second comparative example in which only one of the first negative electrode layer and the second negative electrode layer was laminated. This indicates that the negative electrode in which the second negative electrode layer is laminated on the first negative electrode layer has improved charge-discharge characteristics. It is considered that this is because the growth of the lithium metal layer between the first negative electrode layer and the second negative electrode layer inhibits the generation of the dendrite D, and inhibits the side reaction with the electrolytic solution and the generation of the isolated Li metal, and therefore the irreversible capacity is reduced.

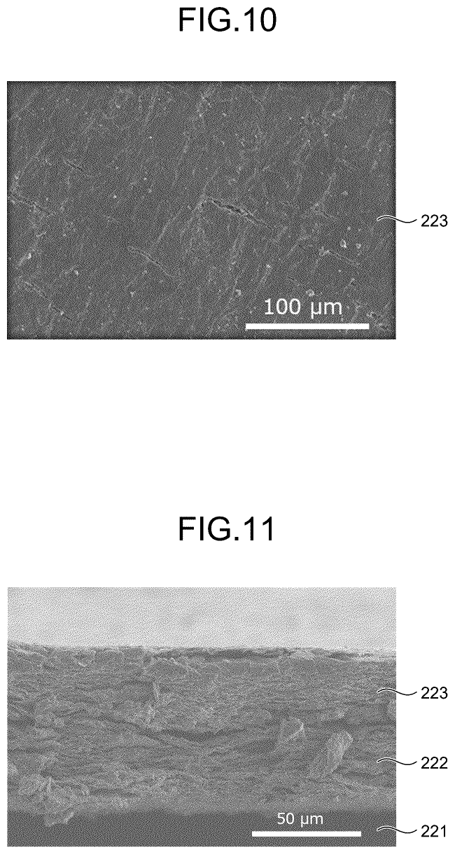

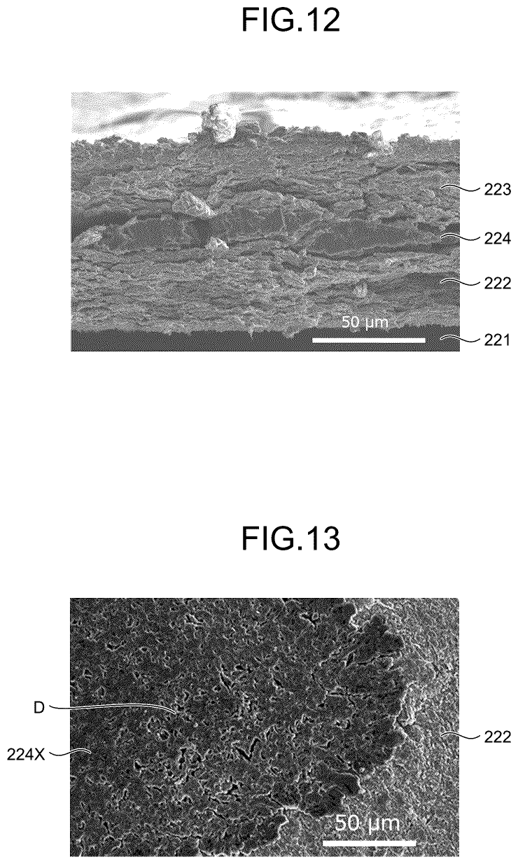

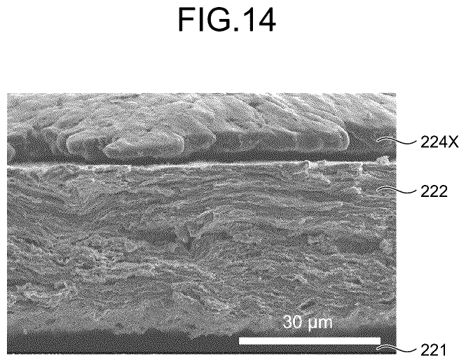

FIG. 10 is a view illustrating an SEM observation image of a surface of the negative electrode on the separator side according to the first example. FIGS. 11 and 12 are views each illustrating an SEM observation image of a section of the negative electrode according to the first example. Here, FIG. 11 is an SEM observation image of the negative electrode of Example 1 before the charge test, and FIG. 12 is an SEM observation image of the negative electrode of the first example after the charge test. FIG. 13 is a view illustrating an SEM observation image of a surface of the negative electrode on the separator side according to the first comparative example. FIG. 14 is a view illustrating an SEM observation image of a section of the negative electrode according to the first comparative example. As illustrated in FIGS. 13 and 14, the lithium metal layer 224X in which the dendrites D were generated on the surface was formed on the surface of the negative electrode according to the first comparative example on the separator side. On the other hand, as illustrated in FIG. 10, a lithium metal layer was not generated on the surface of the negative electrode according to the first example on the separator side (the surface of the second negative electrode layer 223). As illustrated in FIGS. 11 and 12, in the negative electrode according to the first example, the lithium metal layer 224 was formed between the first negative electrode layer 222 and the second negative electrode layer 223 by charging. As can be seen from this, since the second negative electrode layer 223 free from lithium alloy particles is laminated on the first negative electrode layer 222 containing lithium alloy particles, the lithium metal layer 224 is generated between the first negative electrode layer 222 and the second negative electrode layer 223 by charging, and the lithium metal layer 224 is covered with the second negative electrode layer 223. It is considered from the result in FIG. 8 that this is because the lithium metal layer is preferentially formed on the surface of the first negative electrode layer 222 containing the lithium alloy particles rather than on the surface of the second negative electrode layer 223 free from the lithium alloy particles.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A secondary battery comprising: a positive electrode; and a negative electrode,
wherein the negative electrode includes
a negative electrode current collector,
a first negative electrode layer being provided on the negative electrode current collector and containing graphene,
a lithium metal layer being provided on the first negative electrode layer, the lithium metal layer containing a lithium metal and not including graphene, and
a second negative electrode layer being provided on the lithium metal layer and containing graphene, and
in a state in which a potential of the negative electrode is 0 V versus Li/Li⁺,
the first negative electrode layer includes lithium alloy particles containing lithium and a metal that forms an alloy with the lithium, and
a mass fraction of the lithium alloy particles in the first negative electrode layer is larger than a mass fraction of the lithium alloy particles in the second negative electrode layer.

2. The secondary battery according to claim 1, wherein the mass fraction of the lithium alloy particles in the first negative electrode layer is 10 mass % or more and 50 mass % or less.

3. The secondary battery according to claim 1, wherein at least one of the first negative electrode layer or the second negative electrode layer contains a reduced graphene oxide.

4. The secondary battery according to claim 1, wherein an adhesive force between the first negative electrode layer and the lithium metal layer is larger than an adhesive force between the second negative electrode layer and the lithium metal layer.

5. The secondary battery according to claim 1, wherein the metal that forms an alloy with the lithium is at least one of Zn, Si, Mg, Al, Au, Pt, or Ag.

6. The secondary battery according to claim 1, wherein an absolute value of lithium nucleation overvoltage in the first negative electrode layer is smaller than an absolute value of lithium nucleation overvoltage in the second negative electrode layer.

7. A negative electrode comprising:
a negative electrode current collector,
a first negative electrode layer being provided on the negative electrode current collector and containing graphene,
a lithium metal layer being provided on the first negative electrode layer, the lithium metal layer containing lithium metal and not including graphene, and
a second negative electrode layer being provided on the lithium metal layer and containing graphene, and
in a state in which a potential of the negative electrode is 0 V versus Li/Li⁺,
the first negative electrode layer includes lithium alloy particles containing lithium and a metal that forms an alloy with the lithium, and
a mass fraction of the lithium alloy particles in the first negative electrode layer is larger than a mass fraction of the lithium alloy particles in the second negative electrode layer.

8. The negative electrode according to claim 7, wherein the mass fraction of the lithium alloy particles in the first negative electrode layer is 10 mass % or more and 50 mass % or less.

9. The negative electrode according to claim 7, wherein at least one of the first negative electrode layer or the second negative electrode layer contains reduced graphene oxide.

10. The negative electrode according to claim 7, wherein an adhesive force between the first negative electrode layer and the lithium metal layer is larger than an adhesive force between the second negative electrode layer and the lithium metal layer.

11. The negative electrode according to claim 7, wherein the metal that forms an alloy with the lithium is at least one of Zn, Si, Mg, Al, Au, Pt, or Ag.

12. The negative electrode according to claim 7, wherein an absolute value of lithium nucleation overvoltage in the first negative electrode layer is smaller than an absolute value of lithium nucleation overvoltage in the second negative electrode layer.

13. A method for producing a negative electrode, the method comprising:
providing a first negative electrode layer containing graphene on a negative electrode current collector,
providing a second negative electrode layer containing graphene on the first negative electrode, and
forming a lithium metal layer between the first negative electrode layer and the second negative electrode layer by charging, and
the first negative electrode layer includes metal compound particles containing a metal that forms an alloy with lithium, and
a mass fraction of the metal compound particles in the first negative electrode layer is larger than a mass fraction of the metal compound particles in the second negative electrode layer.

14. The method for producing a negative electrode according to claim 13, further including forming a lithium alloy particles containing lithium and the metal that forms an alloy with the lithium from the metal compound particles by the charging.

15. The method for producing a negative electrode according to claim 14, wherein the mass fraction of the lithium alloy particles in the first negative electrode layer is 10 mass % or more and 50 mass % or less.

16. The method for producing a negative electrode according to claim 13, wherein the metal compound particles are metal oxide particles.

17. The method for producing a negative electrode according to claim 13, wherein at least one of the first negative electrode layer or the second negative electrode layer contains reduced graphene oxide.

18. The method for producing a negative electrode according to claim 13, wherein an adhesive force between the first negative electrode layer and the lithium metal layer is larger than an adhesive force between the second negative electrode layer and the lithium metal layer.

19. The method for producing a negative electrode according to claim 13, wherein the metal that forms an alloy with the lithium is at least one of Zn, Si, Mg, Al, Au, Pt, or Ag.

20. The method for producing a negative electrode according to claim 13, wherein an absolute value of lithium nucleation overvoltage in the first negative electrode layer is smaller than an absolute value of lithium nucleation overvoltage in the second negative electrode layer.
